(19) United States
(12) Patent Application Publication
(10) Pub. No.: US 2004/0197638 A1
(43) Pub. Date: Oct. 7, 2004

(54) Fuel cell electrode comprising carbon nanotubes

(76) Inventors: Kenneth O. McElrath, Houston, TX (US); Kenneth A. Smith, Houston, TX (US); Jeffrey L. Bahr, Houston, TX (US); Thomas J. Wainerdi, Katy, TX (US); David A. Karohl, Houston, TX (US); Daniel T. Colbert, Houston, TX (US); Michael Andrew Miller, San Antonio, TX (US); Henry Wayne Oviatt, San Antonio, TX (US); Eric D. Cline, Westfield, NJ (US)

Correspondence Address: Kenneth D. Goodman, Williams, Morgan & Amerson, P.C., Suite 1100, 10333 Richmond, Houston, TX, 77042, US

(21) Appl. No.: 10/698,964

(22) Filed: Oct. 31, 2003

Related U.S. Application Data
(60) Provisional application No. 60/422,799, filed on Oct. 31, 2002.
(60) Provisional application No. 60/468,326, filed on May 6, 2003.
(60) Provisional application No. 60/501,707, filed on Sep. 2, 2003.

(51) Int. Cl. H01M 4/96; H01M 4/92; B05D 5/12; H01M 8/10; H01M 4/88

(52) U.S. Cl. 429/44; 502/101; 429/30; 427/115

(57) ABSTRACT

Electrodes for polymer electrolyte membrane and direct methanol fuel cells comprise carbon nanotubes and catalytically active metal. In one embodiment, anode electrodes are prepared by depositing catalytic metal on carbon nanotubes, and forming the carbon nanotubes into a membrane. Anode electrodes comprising carbon nanotubes provide higher fuel cell performance with a much lower platinum loading than conventional carbon-based electrode material having a much higher platinum loading. In another embodiment, a catalyst ink comprising carbon nanotubes and a catalytic metal-loaded carbon powder was used to form an electrode membrane. The catalyst ink comprising carbon nanotubes and catalyst-loaded carbon powder can optionally comprise an ionically conductive polymer, such as a perfluorosulfonic acid/PTFE copolymer. In another embodiment, a fuel cell electrode comprising carbon nanotubes and catalytically active metal is a free-standing electrode. In another embodiment of a membrane electrode assembly, carbon nanotubes are sandwiched between a catalyst-loaded electrode and a polymer electrolyte membrane.

### CROSS-REFERENCE TO RELATED APPLICATIONS

The present application claims priority to the following U.S. Provisional Patent Application: Serial No. 60/422,799, filed Oct. 31, 2002, Serial No. 60/468,326, filed May 6, 2003, and Serial No. 60/501,707, filed Sep. 2, 2003, all of which are incorporated herein by reference.

### FIELD OF THE INVENTION

This invention relates generally to a fuel cell comprising carbon nanotubes, and more particularly, a fuel cell electrode comprising carbon nanotubes, and method for making the same.

### BACKGROUND OF THE INVENTION

Fuel cells are electrochemical devices that convert fuel to electricity and a reaction product. Because of their high power density, the rate at which an amount of energy can be transferred in or out of a unit weight or volume, low operating temperatures, fast response times, and convenient cell designs, one of the most promising types of fuel cell is the Proton Exchange Membrane fuel cell (PEM or PEMFC), also known as Polymer Electrolyte Membrane (PEM) fuel cell. A typical proton exchange fuel cell consists of a proton conducting electrolyte membrane sandwiched in between two electrodes, an anode electrode and a cathode electrode. The use of a solid polymer electrolyte membrane eliminates the corrosion and safety concerns associated with liquid electrolyte fuel cells. The anode and cathode electrodes have been conventionally prepared from a platinum metal-containing catalyst supported on a porous carbon material.

Depending on the particular proton exchange membrane, PEM fuel cells can operate over a range of about 50 and 200° C., but typically operate in the range of about 70 to 150° C. Their low operating temperature provides instant start-up. About 50% of maximum power is available immediately at room temperature.

When hydrogen is the fuel in a PEM fuel cell, hydrogen is oxidized to form water and produce direct current electric power. Hydrogen is supplied to the anode where a catalyst, such as platinum, catalyzes the following reaction:

Anode reaction: 2H₂→4H⁺+4e⁻

At the anode, hydrogen separates into hydrogen ions (protons) and electrons. The protons migrate from the anode through the proton exchange membrane to the cathode. The electrons migrate from the anode through an external circuit in the form of electricity. An oxidant, in the form of oxygen or oxygen-containing air, is supplied to the cathode, where it reacts with the hydrogen ions that have crossed the membrane and with the electrons from the external circuit to form water as the reaction byproduct. The reaction is typically catalyzed by platinum or platinum in combination with other catalytic metals. The reaction at the cathode is as follows:

Cathode reaction: 1/2O₂+4H⁺+4 e⁻→2H₂O

Another type of fuel cell for portable power devices is the direct methanol fuel cell (DMFC). Direct methanol fuel cells are similar to the proton exchange membrane fuel cells in that they both use a polymer membrane as the electrolyte. However, in the direct methanol fuel cell, the anode catalyst itself draws the hydrogen from the liquid methanol, eliminating the need for a fuel reformer. Methanol is electrochemically oxidized at the anode to produce electrons which travel through an external circuit to the cathode. The anode reaction of methanol is given in the following reaction.

Anode reaction: CH₃OH+H₂O→CO₂+6H⁺+6e⁻

The protons travel through the polymer electrolyte membrane and a reduction reaction with oxygen occurs at the cathode according to the following reaction.

Cathode reaction: 3/2O₂+6H⁺+6e⁻→3H₂O

The overall reaction in the DMFC reflects the combustion of methanol, shown as follows.

CH₃OH^{+3/2O}₂→CO₂+2H₂O

Direct methanol fuel cells can operate at temperatures over a range of about 50° C. and 200° C., and typically operate in a range of about 50° C. and 90° C. Higher efficiencies are obtainable at higher temperatures. Similar fuel cells can also operate on other fuels, such as ethanol and gasoline.

The composition and construction of the electrode have a large impact on fuel cell design and performance. Desirable attributes of the electrode material include, among other qualities, high surface area and electrical and thermal conductivity. One aspect of particular interest in conventional PEM fuel cell electrodes is the limited accessible surface area of the platinum catalyst metal on porous carbon electrodes. Providing more catalyst metal area often leads to higher catalyst loadings and associated catalyst costs. A finer dispersion of platinum metal would increase the catalyst surface area and accessibility for a given weight of catalyst metal. This increase in catalyst surface area provides a means to increase the performance of the fuel cell and/or provide a means for reducing the amount of platinum catalyst metal and the associated cost of catalyst in the fuel cell.

In fuel cell electrodes, it is particularly desirable that the catalyst particles reside in close proximity to, and ideally in contact with, the proton exchange membrane and the electrical conductor, that the catalyst particles have a large amount of accessible surface area, and that the fuel cell electrode material shows low resistive losses. There remains a need for an electrode material that provides higher fuel cell performance while minimizing the amount of expensive catalytic metal and associated costs.

### SUMMARY OF THE INVENTION

One aspect of the invention is a proton electrolyte membrane fuel cell electrode that comprises a plurality of carbon nanotubes and a catalyst metal. The plurality of carbon nanotubes forms a mat of carbon nanotubes, wherein the mat has a planar area and the mat has a thickness greater than one micron. The catalyst metal is selected from the group consisting of Group VI elements, Group VII elements, Group VIII elements, copper, silver, gold, zinc, tin, aluminum, and combinations thereof, in contact with the mat of carbon nanotubes.

Another aspect of the invention is a method for preparing a fuel cell membrane electrode. The method comprises associating a catalytic metal, as described above, in contact with a plurality of carbon nanotubes, to form a plurality of carbon nanotubes with associated catalytic metal, and forming a membrane electrode comprising a plurality of carbon nanotubes with associated catalytic metal.

Another aspect of the invention is a membrane electrode assembly, comprising a proton exchange membrane, an anode electrode, a cathode electrode and carbon nanotubes. The carbon nanotubes are positioned between the anode electrode and the proton exchange membrane.

Another aspect of the invention is a method for preparing a membrane electrode assembly, comprising preparing an ink comprising carbon nanotubes and a transition metal, and coating the ink on one or more sides of a proton exchange membrane.

Another aspect of the invention is a catalyst ink comprising carbon nanotubes and catalytic metal as described above.

Another aspect of the invention is a PEM fuel cell comprising an anode electrode, a cathode electrode and a proton exchange membrane. The anode electrode comprises single-wall carbon nanotubes and the single-wall carbon nanotubes support platinum-containing metal particles.

In one embodiment, a fuel cell electrode comprises carbon nanotubes, wherein the carbon nanotubes may be derivatized with one or more functional groups on their end or wall structure, and wherein the carbon nanotubes support catalyst metal effective for catalyzing the fuel cell reactions. The carbon nanotubes can be single-wall, multi-wall or a combination thereof. The catalyst metal can comprise one or more elements wherein the catalyst metal is catalytically active in an electrochemical cell, such as a fuel cell.

In another embodiment, a fuel cell, which can be a PEM fuel cell or a direct methanol fuel cell (DMFC), comprises one or more electrodes comprising carbon nanotubes, wherein the carbon nanotubes support metal particles that are catalytically active for reactions of the fuel cell, and wherein the electrodes are in contact with a proton exchange membrane. The carbon nanotubes, which can be single-wall, multi-wall carbon or a combination thereof, can be pristine or derivatized with a functional group. The catalytic metal can comprise a metal selected from the group consisting of Group VI, which includes chromium (Cr), molybdenum (Mo) and tungsten (W), Group VII, which includes manganese (Mn), technetium (Tc) and rhenium (Re), Group VIII, which includes iron (Fe), ruthenium (Ru), osmium (Os), cobalt (Co), rhodium (Rh), iridium (Ir), nickel (Ni), palladium (Pd), and platinum (Pt), copper (Cu), silver (Ag), gold (Au), zinc (Zn), tin (Sn), aluminum (Al), or combinations thereof.

In one embodiment, a method for preparing a fuel cell membrane electrode comprises depositing a catalyst metal on a plurality of carbon nanotubes to form a plurality of carbon nanotubes with associated catalyst metal, and forming a membrane electrode comprising the plurality of carbon nanotubes with associated catalyst metal. The carbon nanotubes, which can be single-wall, multi-wall, or a combination thereof, can be pristine or derivatized with functional groups. The depositing can be done by chemical deposition, electrochemical deposition, evaporative sputtering, molecular beam epitaxy, and combinations thereof.

Another embodiment of this invention is a method for forming a free-standing electrode comprising carbon nanotubes and catalytic metal. Such an electrode may be in the form of a membrane, and can be formed by filtering a suspension comprising carbon nanotubes, on which is attached catalyst metal or catalyst metal precursors, to make a “buckypaper” of carbon nanotubes with attached catalyst metal or catalyst metal precursors. “Buckypaper”, which resembles a thin mat, is the filter cake remaining after filtering a small amount of carbon nanotubes suspended in a liquid. The electrode membrane may be formed with carbon nanotubes having attached catalyst metal particles or catalyst metal precursors; or it may alternatively be fabricated first, and subsequently have the catalyst material deposited on it. Deposition methods include, but are not limited to, deposition from solution, electrolytic deposition, vacuum deposition, sputtering, painting, impregnation from solution, and combinations thereof.

In another embodiment, a fuel cell membrane electrode comprises a dried catalytic ink comprising carbon nanotubes and catalytic metal effective for catalyzing fuel cell reactions. The catalytic ink can further comprise a carbon powder, and optionally, an ionomeric resin compatible with the particular proton exchange membrane. The catalytic metal can reside on the carbon nanotubes, on the carbon powder, if present, or on a combination of both. In another embodiment, a method for forming a membrane electrode assembly comprises applying a catalytic ink to a surface of a proton exchange membrane, wherein the catalytic ink comprises carbon nanotubes and a catalytic metal. Optionally, the catalytic ink can further comprise a carbon component other than carbon nanotubes and an ionomeric resin compatible with the proton exchange membrane. The catalytic ink can be applied directly to the proton exchange membrane or to another surface such that the catalytic ink is contacted with the proton exchange membrane for use in a membrane electrode assembly (MEA).

Another embodiment of this invention is a method for forming a fuel cell electrode from a catalyst ink comprising a suspension of carbon nanotubes in a liquid, wherein the carbon nanotubes support, or are in contact with, catalyst metal particles or catalyst metal precursors. For a fuel cell application, the electrode may be formed by deposition of the catalyst ink directly on the proton electrolyte membrane (PEM), a fuel cell component, such as the gas diffusion layer (GDL), or a combination thereof. The suspending liquid can be an aqueous or organic solvent or combination thereof. If the catalyst ink is deposited on another component of the fuel cell, such as a gas diffusion layer, then the catalyst ink-side of the GDL is, subsequently, put in contact with the proton exchange membrane when forming a membrane electrode assembly. The deposition of the catalyst ink on to the PEM or other fuel cell component, can be by may be by any effective means of ink deposition. Such techniques include, but are not limited to, painting, spraying, subliming, electrolytic deposition, centrifugation, filtering, filtering the suspension using a fuel cell component, such as a GDL, and combinations thereof.

Another embodiment of the invention is a PEM fuel cell wherein a layer of carbon nanotubes without catalyst is in contact with the proton exchange membrane and an electrode. The carbon nanotubes can be single-wall, multi-wall, or a combination of both. The layer of carbon nanotubes is contacted with the proton exchange membrane and an anode material containing fuel cell catalytic metals is contacted with the carbon nanotube layer. The layer of carbon nanotubes can comprise an ionomer that is the same or compatible with the proton exchange membrane. The layer may be made by mixing the nanotubes, and optional ionomer resin, with a liquid and applying the nanotubes to the surface of the PEM and allowing the liquid to evaporate. An electrode material is contacted with the nanotube layer and can be applied as a catalyst ink, or as a free-standing electrode and adhered to the nanotube layer with pressure and, optionally, heat.

Carbon nanotubes in fuel cell electrodes provide the opportunity for new and less expensive fuel cell designs having much lower catalyst metal loadings on the electrodes. For example, the use of carbon nanotubes, and in particular, single-wall carbon nanotubes, provide high electrical conductivity in the electrode material, which enables fabrication of fuel cells without multiple electrical contacts to the electrode. The conductivity and porosity of a mat of single-wall carbon nanotubes can serve multiple functions, such as those of the fuel cell bipolar plates and gas diffusion layers, thus permitting elimination of those elements and providing for simpler, lower cost, fuel cell designs.

### BRIEF DESCRIPTION OF THE DRAWINGS

FIG. 1 is a schematic drawing of a polymer electrolyte membrane (PEM) fuel cell.

FIG. 2 shows a graph the performance of a PEM fuel cell utilizing an anode electrode prepared according to one embodiment of the present invention with that of a fuel cell utilizing a commercially-available anode material.

Curve A gives the performance of a PEMFC with an anode electrode comprising 2 mg single-wall carbon nanotubes with a catalyst metal loading of 7.61 μm Pt/cm² of planar PEM area.

Curve B gives the performance of a PEMFC with a commercial E-TEK anode electrode having a catalyst metal loading of 400 μm Pt/cm² of planar PEM area.

FIG. 3 shows a graph comparing the performance of PEM fuel cells having different anode electrodes comprising Pt supported on SWNT prepared according to an embodiment of the present invention with that of a fuel cell utilizing a commercially-available anode material.

Curve A gives the performance of a PEMFC with an anode electrode comprising 1 mg single-wall carbon nanotubes with a catalyst metal loading of 3.80 μm Pt/cm² of planar PEM area.

Curve B gives the performance of a PEMFC with an anode electrode comprising 2 mg single-wall carbon nanotubes with a catalyst metal loading of 7.61 μm Pt/cm² of planar PEM area.

Curve C gives the performance of a PEMFC with an anode electrode comprising 4 mg single-wall carbon nanotubes with a catalyst metal loading of 15.22 μm Pt/cm² of planar PEM area.

Curve D gives the performance of a PEMFC with an anode electrode comprising 8 mg single-wall carbon nanotubes with a catalyst metal loading of 30.44 μm Pt/cm² of planar PEM area.

Curve E gives the performance of a PEMFC with a commercial E-TEK anode electrode having a catalyst metal loading of 400 μm Pt/cm² of planar PEM area.

FIG. 4 shows a graph comparing the performance of hydrogen/oxygen PEM fuel cells with different constructions.

Curve A represents a PEMFC cell with electrodes prepared from a catalytic ink without addition of single-wall carbon nanotubes.

Curve B represents a PEMFC with a commercial MEA (E-TEK).

Curve C represents a fuel cell in which the catalytic ink in the anode and cathode electrodes comprises single-wall carbon nanotubes.

Curve D represents a PEMFC in which the catalytic ink in only the anode electrode comprises single-wall carbon nanotubes.

FIG. 5 shows a graph comparing the performance of direct methanol fuel cells (DMFCs) operating with 1M methanol at 25° C. according to one embodiment of the present invention.

Curve A represents the performance of a DMFC having a NAFION PEM and an anode electrode made with a standard Pt—Ru catalyst ink.

Curves B, C and D represent the performance of DMFCs having a layer of single-wall carbon nanotubes mixed with NAFION between a NAFION PEM and the anode electrode made with a standard Pt—Ru catalyst ink.

FIG. 6 shows a graph comparing the performance of DMFCs operating with 1M methanol at 50° C. according to one embodiment of the present invention.

Curve A represents the performance of a DMFC having a NAFION PEM and an anode electrode made with a standard Pt—Ru catalyst ink.

Curves B and C represent the performance of DMFCs having a layer of single-wall carbon nanotubes mixed with NAFION between a NAFION PEM and the anode electrode made with a standard Pt—Ru catalyst ink.

FIG. 7 shows a graph comparing the performance of DMFCs operating with 3M methanol at 30° C. according to one embodiment of the present invention.

Curve A represents the performance of a DMFC having a NAFION PEM and an anode electrode made with a standard Pt—Ru catalyst ink.

Curve B represents the performance of a DMFC having a layer of single-wall carbon nanotubes mixed with NAFION between a NAFION PEM and the anode electrode made with a standard Pt—Ru catalyst ink.

### DETAILED DESCRIPTION OF SPECIFIC EMBODIMENTS

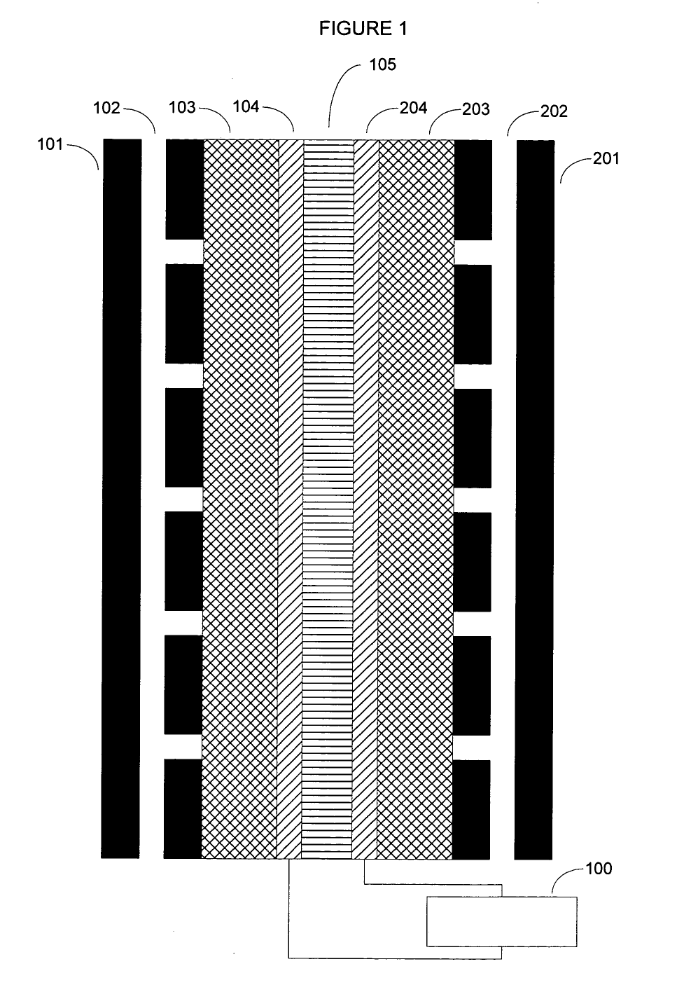

A diagram of a typical polymer electrolyte membrane (PEM) fuel cell is shown in FIG. 1. In this type of fuel cell, a fuel gas or fuel gas mixture, such as hydrogen in a hydrogen-oxygen fuel cell, enters the inlet feed gas channel, 102, in the anode-side bipolar plate, 101, diffuses through the anode-side gas diffusion layer 103 and enters the catalyst-containing anode electrode 104. In the anode electrode 104, comprising catalyst particles, such as platinum or any other transition metal or metal combination effective for catalyzing fuel cell oxidation reactions, the hydrogen is dissociated into protons and electrons. An electrical potential difference between the anode electrode and cathode electrode provides the driving force for the electrons to flow out of the anode electrode 104 as electrical current, through external electrical circuitry having an, electrical load 100 and back to the cathode electrode 204. The protons generated from the dissociated hydrogen leave the anode electrode 104 and migrate through the polymer electrolyte membrane 105 to the cathode electrode 204. The cathode electrode 204, which can be the same or different than the anode, also contains catalyst particles, such as platinum or any other transition metal or metal combination effective for catalyzing fuel cell reduction reactions. In a hydrogen-oxygen fuel cell, oxygen or an oxygen-containing gas, such as air, enters the gas channel 202 of the cathode-side bipolar plate 201, diffuses through the cathode-side gas diffusion layer 203 and into the cathode electrode 204. On the cathode electrode 204 which comprises catalyst particles cited earlier, water is formed from the oxygen entering the cathode-side bipolar plate 201, the protons that migrated through the polymer electrolyte membrane 105 and the electrons from the anode electrode 104 that passed through the electrical load 100. The water formed then migrates out through the cathode-side gas diffusion layer 203 and exits through the channels in the cathode-side bipolar plate 201. The portion of the fuel cell consisting of the polymer electrolyte membrane and the electrodes is often referred to as the “membrane electrode assembly” or MEA.

Embodiments of the present invention provide a means of enhancing the performance a PEM fuel cell through the incorporation of carbon nanotubes in the anode electrode, the cathode electrode or both. With the enhanced performance, design changes that result in smaller and lower cost fuel cells can be achieved.

In one embodiment of the present invention, the carbon nanotubes incorporated into a fuel cell electrode or fuel cell construction are single-wall carbon nanotubes. Single-wall carbon nanotubes (SWNT) are hollow, tubular fullerene molecules consisting essentially of sp²-hybridized carbon atoms typically arranged in hexagons and pentagons. Single-wall carbon nanotubes typically have diameters in the range of about 0.7 nanometers (nm) and about 3.5 nm, and lengths usually greater than about 50 nm. Single-wall carbon nanotubes have exceptional physical properties including high strength, stiffness, thermal and electrical conductivity.

In other embodiments of the present invention, the carbon nanotubes incorporated into a fuel cell or fuel cell construction can be multi-wall carbon nanotubes, which resemble nested single-wall carbon cylinders of two or more carbon cylinders. Multi-wall carbon nanotubes possess properties similar to the single-wall carbon nanotubes, however, single-wall carbon nanotubes generally have fewer defects, rendering them stronger, and typically, more conductive than multi-wall carbon nanotubes of similar diameter. Single-wall carbon nanotubes are believed to be much less prone to defects than are multi-wall carbon nanotubes because multi-wall carbon nanotubes can survive the incorporation of defects by forming bridges between the unsaturated carbon of the neighboring cylinders, whereas single-wall carbon nanotubes have no neighboring walls for defect compensation.

Both single-wall and multi-wall carbon nanotubes can form porous materials that are highly electrically-conductive. This electrical conductivity can reduce electrical loss in an electrode structure and provide greater fuel cell design flexibility. The incorporation of carbon nanotubes in fuel cell electrode structures enhances fuel cell efficiency. This increased efficiency, in turn, reduces the amount of metal catalyst required to achieve a specific current density from the cell electrode assembly. The incorporation of carbon nanotubes in fuel cell electrodes provides a means of increasing fuel cell current density at reduced catalyst loadings. Single-wall carbon nanotubes in fuel cell electrodes are a preferred embodiment. In one embodiment, a fuel cell electrode comprising single-wall carbon nanotubes provides more than twice the current density of a comparable conventional electrode, while having a platinum catalyst loading that is more than a factor of ten less. This high current density achieved at highly reduced catalyst loadings can result in more efficient, less expensive fuel cells.

Carbon nanotubes can be made from a carbon feedstock by any known means, such as, catalytic vapor deposition using carbon-containing feedstocks and metal catalyst particles, laser ablation, arc method, or any other method for synthesizing carbon nanotubes. Single-wall carbon nanotubes can also be synthesized by gas-phase synthesis from high temperature, high pressure carbon monoxide. Metals, such as Group VIB and/or VIIIB transition elements, are common catalysts for the synthesis of single-wall carbon nanotubes. The single-wall carbon nanotubes obtained from synthesis are generally in the form of single-wall carbon nanotube powder.

The carbon nanotubes can optionally be purified to remove non-nanotube carbon, such as amorphous carbon and metallic catalyst residues. After synthesis of the nanotubes, the metallic residues may be encapsulated in non-nanotube carbon, such as graphitic shells of carbon. The metallic impurities may also be oxidized through contact with air or by oxidation of the non-nanotube carbon during purification.

Purification can be done by any known means. Procedures for purification of single-wall carbon nanotubes are related in International Patent Publications “Process for Purifying Single-Wall Carbon Nanotubes and Compositions Thereof,” WO 02/064,869, published Aug. 22, 2002, and “Gas Phase Process for Purifying Single-Wall Carbon Nanotubes and Compositions Thereof,” WO 02/064,868 published, Aug. 22, 2002, and incorporated herein in their entirety by reference. In one embodiment, the nanotubes are purified by heating at 250° C. in air saturated with water vapor. The heating is done for a length of time so as to oxidize at least some of the non-nanotube carbon, and, may, to some extent, oxidize the metal impurities. The oxidation temperature can be in the range of 200° C. and about 400° C., preferably about 200° C. to about 300° C. The oxidation can be conducted in any gaseous oxidative environment, which can comprise oxidative gases, such as oxygen, air, carbon dioxide, and combinations thereof. The concentration of the oxidative gases can be adjusted and controlled by blending with nitrogen, an inert gas, such as argon, or combinations thereof. The duration of the oxidation process can range from a few minutes to days, depending on the oxidant, its concentration, and the oxidation temperature. After oxidatively heating the nanotubes, the nanotubes are treated with acid to remove metallic impurities. In one embodiment, the nanotubes are slurried in the acid, which can be a mineral acid, an organic acid, or combinations thereof. Examples of acids that could be used to treat and slurry the nanotubes include, but are not limited to, hydrochloric acid, hydrofluoric acid, hydrobromic acid, hydroiodic acid, sulfuric acid, oleum, nitric acid, citric acid, oxalic acid, chlorosulfonic acid, phosphoric acid, trifluoromethane sulfonic acid, glacial acetic acid, monobasic organic acids, dibasic organic acids, and combinations thereof. The acid used can be a pure acid or diluted with a liquid medium, such as an aqueous and/or organic solvent. Generally, an aqueous solvent is preferred. Concentrated aqueous hydrochloric acid is preferred for removing metallic impurities. After acid treating, the acid and impurities are removed from the nanotubes by rinsing. The nanotubes can be rinsed with water, an organic solvent or a combination thereof.

The carbon nanotubes can be optionally derivatized with one or more functional groups. The derivatization of the carbon nanotubes facilitates the supporting of the catalytic metal on the nanotubes by promoting chemical bonding, chelating or creating a polar attraction of the catalyst metal species to the ends and/or sidewalls of the carbon nanotubes. For example, carboxylic acid functional groups on a carbon nanotube could bond, chelate or provide a polar attraction to catalytic metal species and promote a metal-nanotube interaction. The functionality on the nanotubes provides “docking sites” for catalyst metals and catalyst metal precursors, so that, the metal remains in contact with the nanotube through the supporting treatments, such as rinsing off unreacted metal-containing compounds in metal loading of the support.

The carbon nanotubes can be derivatized on their ends or sides with functional groups, such as carboxylic acid, alkyl, acyl, aryl, aralkyl, halogen; substituted or unsubstituted thiol; unsubstituted or substituted amino; hydroxy, and OR′ wherein R′ is selected from the group consisting of alkyl, acyl, aryl aralkyl, unsubstituted or substituted amino; substituted or unsubstituted thiol, and halogen; and a linear or cyclic carbon chain optionally interrupted with one or more heteroatom, and optionally substituted with one or more ═O, or ═S, hydroxy, an aminoalkyl group, an amino acid, or a peptide. Typically, the number of carbon atoms in the alkyl, acyl, aryl, aralkyl groups is in the range of 1 to about 30, and in some embodiments in the range of 1 to about 10.

The following definitions are used herein.

The term “alkyl” as employed herein includes both straight and branched chain radicals; for example methyl, ethyl, propyl, isopropyl, butyl, t-butyl, isobutyl, pentyl, hexyl, isohexyl, heptyl, 4,4-dimethylpentyl, octyl, 2,2,4-trimethylpentyl, nonyl, decyl, undecyl, dodecyl, the various branched chain isomers thereof. The chain may be linear or cyclic, saturated or unsaturated, containing, for example, double and triple bonds. The alkyl chain may be interrupted or substituted with, for example, one or more halogen, oxygen, hydroxy, silyl, amino, or other acceptable substituents.

The term “acyl” as used herein refers to carbonyl groups of the formula —COR wherein R may be any suitable substituent such as, for example, alkyl, aryl, aralkyl, halogen; substituted or unsubstituted thiol; unsubstituted or substituted amino, unsubstituted or substituted oxygen, hydroxy, or hydrogen.

The term “aryl” as employed herein refers to monocyclic, bicyclic or tricyclic aromatic groups containing from 6 to 14 carbons in the ring portion, such as phenyl, naphthyl substituted phenyl, or substituted naphthyl, wherein the substituent on either the phenyl or naphthyl may be for example C₁₋₄ alkyl, halogen, C₁₋₄ alkoxy, hydroxy or nitro.

The term “aralkyl” as used herein refers to alkyl groups as discussed above having an aryl substituent, such as benzyl, p-nitrobenzyl, phenylethyl, diphenylmethyl and triphenylmethyl.

The term “aromatic or non-aromatic ring” as used herein are preferably 5-8 membered aromatic and non-aromatic rings uninterrupted or interrupted with one or more heteroatom, for example O, S, SO, SO₂, and N, or the ring may be unsubstituted or substituted with, for example, halogen, alkyl, acyl, hydroxy, aryl, and amino. Said heteroatom and substituent may also be substituted with, for example, alkyl, acyl, aryl, or aralkyl.

The term “linear or cyclic” when used herein includes, for example, a linear chain which may optionally be interrupted by an aromatic or non-aromatic ring. Cyclic chain includes, for example, an aromatic or non-aromatic ring which may be connected to, for example, a carbon chain which either precedes or follows the ring.

The term “substituted amino” as used herein refers to an amino which may be substituted with one or more substituents, for example, alkyl, acyl, aryl, aralkyl, hydroxy, and hydrogen.

The term “substituted thiol” as used herein refers to a thiol which may be substituted with one or more substituents, for example, alkyl, acyl, aryl, aralkyl, hydroxy, and hydrogen.

Catalyst Deposition on the Carbon Electrode Material

After the carbon nanotubes are provided, optionally, purified, and optionally derivatized with one or more functional groups on their ends, sidewalls or both, an electrode is prepared for incorporation into a fuel cell construction. To be catalytically active, the electrode comprises catalytic metals effective for the fuel cell reactions. The catalytic metal can comprise a metal selected from the group consisting of Group VI elements, which includes chromium (Cr), molybdenum (Mo) and tungsten (W), Group VII elements, which includes manganese (Mn), technetium (Tc) and rhenium (Re), Group VIII elements, which includes iron (Fe), ruthenium (Ru), osmium (Os), cobalt (Co), rhodium (Rh), iridium (Ir), nickel (Ni), palladium (Pd), and platinum (Pt), copper (Cu), silver (Ag), gold (Au), zinc (Zn), tin (Sn), aluminum (Al) or combinations thereof. Preferably, the catalytic metal comprises Ru, Rh, Pd, Os, Ir, Pt or a combination thereof. More preferably, the catalytic metal comprises Pt or a metal combination comprising Pt.

The catalyst metals can be deposited on the carbon nanotube ends, interior and/or exterior surfaces by solution chemical deposition, electrochemical deposition, chemical deposition, physical deposition by evaporation, sputtering, molecular beam epitaxy, or a combination thereof. In some embodiments, atoms or molecules, such as polymers, can non-covalently attach to single-wall carbon nanotubes and adhere through wrapping, such as polymer wrapping, or electrostatic attraction, such as by polarization forces or by van der Waals forces. Catalytic metal and catalytic-metal-containing species may attach to the non-covalently derivatized nanotube due to the chemical attraction provided by the non-covalent derivatizing agent. Subsequently, the non-covalent derivatizing agent may be removed (for instance by pyrolysis) to leave the metal in contact with the nanotube. Both covalent derivatization and non-covalent attachment of other chemical species can facilitate the deposition of catalyst metal or catalyst metal precursors onto the carbon nanotube.

In one embodiment, the catalyst metal may be deposited on the carbon nanotubes in their metallic state, preferably, in small, (i.e. Angstrom or nanometer-scale) particulate form. The carbon nanotubes can be pristine, non-covalently derivatized, or can be covalently derivatized with one or more functional groups. Generally, derivatization of a carbon nanotube will refer to the covalent bonding of one or more functional groups to the ends and/or sidewall of the carbon nanotube. Catalyst metal deposition techniques, include, but are not limited to, metal vaporization, sputtering, molecular beam epitaxy, electron beam deposition, electrochemical deposition, such as electroplating and electrodeposition, and combinations thereof. The catalyst metal can be in the form of pre-formed particles which are contacted with the carbon nanotubes.

In another embodiment, the catalyst metal may be deposited on the carbon nanotubes through the use of a catalyst precursor. The single-wall carbon nanotubes can be pristine, non-covalently derivatized, or can be covalently derivatized with one or more functional groups. In the embodiment wherein the carbon nanotube is derivatized with a functional group, a catalyst-containing precursor compound can be reacted or complexed with the functional group. For example, the functional groups on derivatized nanotubes can react or complex with the fuel cell catalyst metal or catalyst metal precursor. Catalyst precursor deposition techniques include, but are not limited to, solution deposition, incipient wetness, ion exchange, and combinations thereof. After deposition, the catalyst precursor may be treated by chemical or physical processes to activate the catalyst to its catalytically-active metallic state. Such treatments can include, but are not limited to, gaseous reduction, chemical reactive reduction, oxidation, heat treatment, chemical reaction with other compounds, and combinations thereof.

In another embodiment, a fuel cell electrode material comprises carbon nanotubes wherein catalyst has been deposited on the nanotubes and wherein the nanotubes are mixed with another carbon form, such as carbon black or carbon powder.

In another embodiment, a fuel cell electrode material comprises carbon nanotubes, wherein the nanotubes are without catalytic metal deposits, and wherein the nanotubes are mixed with another carbon form, such as carbon black or carbon powder, wherein the catalyst has been deposited on the other carbon form.

In another embodiment, a fuel cell electrode material is prepared with carbon nanotubes, wherein the nanotubes are without catalytic metal deposits, wherein the nanotubes are mixed with another carbon form, such as carbon black or carbon powder, and wherein the catalytic metal is deposited on the mixture of the nanotubes and the other carbon form. The catalytic metal deposition can be done by any known methods, such as, but not limited to, chemical deposition, electrochemical deposition, chemical deposition, physical deposition by evaporation, sputtering, molecular beam epitaxy, and combinations thereof.

Regardless of how the catalyst metal particles are deposited on the single-wall carbon nanotubes, any other carbon form, or a combination of both, metal catalyst particles are preferably small, i.e. Angstrom or nanometer-scale. The nanometer-scale size of the single-wall carbon nanotubes provides a large surface area to support a great number of optimally, nanometer-scale finely-divided catalyst particles. Small catalyst particle size is important because smaller catalyst particles result in more available catalyst surface area for fuel cell reactions for a given amount of metal. Generally, catalyst particle diameters of about 1 nm to about 5 nm are preferred. Catalytic metals, such as platinum and other catalytic metals used in fuel cells are generally expensive, and can represent a significant part of the total cost of the fuel cell. Minimizing the amount of catalyst by maximizing the available catalyst surface area is a means for reducing fuel cell cost.

Free Standing Fuel Cell Electrodes Comprising SWNT

In one embodiment, a free-standing, self-supporting electrode layer comprising single-wall carbon nanotubes and catalytic metal is prepared, such as in membrane form, to serve as an electrode for a PEM or DMFC fuel cell. This electrode layer is preferably in the form of a membrane having a thickness greater than one micron.

The self-supporting electrode layer can be made with single-wall carbon nanotubes that have catalytic metal deposited on the nanotubes, or the metal deposits can be applied after a membrane of single-wall carbon nanotubes is prepared.

In one embodiment, a single-wall carbon nanotube membrane can be prepared by filtering a single-wall carbon nanotube suspension. After filtering, the filtrate is generally a thin filter cake of nanotubes, and, after drying, the filtrate is a thin mat of nanotubes typically known as a “buckypaper.” The metal catalyst may be deposited on the nanotubes before, during, or after preparation of the buckypaper membrane electrode. The catalyst can be deposited by solution impregnation, incipient wetness, vaporization, electrolytic deposition, deposition of pre-formed catalyst particles, vacuum deposition, sputtering, painting, or combinations thereof. Preferably, the catalyst metal is deposited on the nanotubes before forming the membrane.

In one embodiment, a membrane comprising single-wall carbon nanotubes also comprises another carbon form, such as carbon black or carbon powder. The catalytic metal can be deposited on the single-wall carbon nanotubes, optionally, on another carbon form, or on a combination of both.

In one embodiment, the membrane comprising carbon nanotubes is contacted with a surface of one or more components of a fuel cell prior to fuel cell assembly. For example, membranes comprising carbon nanotubes can be contacted to one or both sides of the proton exchange membrane. Alternatively, membranes comprising single-wall carbon nanotubes can be contacted to a gas diffusion layer and then contacted to one side of the proton exchange membrane. The catalyst can be deposited on the single-wall carbon nanotubes before or after the contacting the nanotubes to a fuel cell component, before sandwiching the membrane between components. Preferably, the catalytic metal is deposited on the nanotubes, or optional nanotube/carbon powder or carbon black combination, prior to making the electrode membrane.

In another embodiment, the membrane electrode comprising single-wall carbon nanotubes, wherein catalyst is associated with the nanotubes, can be applied to a transfer film, such as PTFE (polytetrafluoroethylene). In such case, the carbon nanotube-side of the film is contacted with the PEM or gas diffusion layer (GDL) and later the transfer film is peeled off. This technique is particularly useful in making the MEAs using heat and pressure. Protective films can be applied to the MEA or portions thereof and press the assembly together with heat and pressure. After the assembly is pressed, the protective film is removed.

In another embodiment, a fuel cell comprises a membrane comprising carbon nanotubes and catalyst particles, wherein the membrane acts both as an electrode and a gas diffusion layer. In another embodiment, a fuel cell comprises a membrane comprising carbon nanotubes and catalyst particles, wherein the membrane acts both as an electrode, a gas diffusion layer and a bi-polar plate.

The membrane electrode comprising carbon nanotubes and catalytically active metal can be used as an anode, a cathode, or both. The amount of catalyst loading and the particular catalyst metals can be different for the anode and the cathode. Generally, the amount of catalytic metal needed for a given fuel cell potential is much less when the electrode comprises carbon nanotubes compared to electrode materials, such as carbon black or carbon powder. Alternatively, similar fuel cell performance can be achieved with a fraction of the catalyst metal by using single-wall carbon nanotubes in the electrodes versus carbon black or carbon powder. A fuel cell membrane electrode assembly (MEA) is commonly evaluated in terms of current density produced (generally mA/cm² electrolyte membrane surface area at a cell potential of 0.6 Volts for hydrogen/oxygen fuel cells) as a function of catalyst weight per planar membrane surface area (generally, μg catalyst/cm²).

The polymer electrolyte membrane is a material that, among other properties, has high proton conductivity, chemically and physical stability, low crossover permeability, and tough mechanical properties. The operating temperature of a fuel cell membrane is highly dependent on the PEM material. For example, NAFION, a perfluorosulfonic acid/PTFE copolymer made by DuPont, generally operates below 100° C. Polybenzimidazole (PBI)-based PEM material can be used in higher temperature applications, such as up to about 600° C.

In one embodiment of the present invention, a single-stack hydrogen/oxygen fuel cell having a MEA with a NAFION N-1135 proton exchange membrane and an anode membrane electrode comprising single-wall carbon nanotubes with a platinum loading of 3.8 μm Pt/cm² planar membrane area, provides, at a cell potential of 0.6 volts, a current density of more than 300 mA/cm², more preferably more than 400 mA/cm², more preferably more than 500 mA/cm², more preferably more than 600 mA/cm², more preferably more than 700 mA/cm², and more preferably more than 800 mA/cm², when operated at 70° C. with hydrogen fuel to the anode and air at the cathode at a H₂/air flow rate of 2/3.5 times the stochiometric value theoretically needed to produce a given cell current output, T_{Anode}/T_{Cathode} of 80° C./70° C. and P_{Anode}/P_{Cathode} of 30 psig/30 psig.

In one embodiment, a hydrogen/oxygen fuel cell of the present invention comprises a MEA with a NAFION N-1135 proton exchange membrane and an anode electrode of single-wall carbon nanotubes with Pt catalyst metal particles, wherein the current density the fuel cell operated at 70° C. with hydrogen fuel to the anode and air at the cathode at a H₂/air flow rate of 2/3.5 times the stochiometric value theoretically needed to produce a given cell current output, T_{Anode}/T_{Cathode} of 80° C./70° C. and P_{Anode}/P_{Cathode} of 30 psig/30 psig, is greater than about 1 mA/cm² per μg Pt/cm² of planar PEM area, more preferably in excess of 10 mA/cm² per g Pt/cm² planar PEM area, more preferably in excess of 50 mA/cm² per μg Pt/cm² planar PEM area, and most preferably excess of 100 mA/cm² per μg Pt/cm² planar PEM area.

In another embodiment, the invention involves a multi-stack fuel cell which comprises more than one single-stack fuel cell, wherein at least one electrode of the multi-stack fuel cell comprises single-wall carbon nanotubes and catalytic metal particles.

Besides the surface area of the catalyst particles, the operational effectiveness of a fuel cell is highly dependent the on the three-way contact between the reactant, such as the fuel, the catalyst metal particles and the proton-conducting electrolyte material. In fuel cell electrodes, carbon nanotubes, and particularly single-wall nanotubes, increase the effectiveness of the cell, largely because of the unique combination of electrical conductivity, small physical size of the individual nanotubes, which, for single-wall carbon nanotubes, are generally about 1 nm in diameter, and high aspect ratio (ratio of length to diameter). The small diameters of single-wall carbon nanotubes provide a very large surface area (˜1000 m²/g) to support the catalyst particles. The catalyst particles can be in contact with any portion of the single-wall carbon nanotube, including the end, interior, and/or exterior surfaces. The high aspect ratios of single-wall carbon nanotubes facilitate the formation of conducting networks throughout the electrode. The conductive network provided by the sinuous (spaghetti-like) structure of the carbon nanotubes provides charge transport to and from the catalyst particles. Since carbon nanotubes are excellent electron conductors, their presence in an electrode material provides electron conduction from the catalyst particle through the anode electrode to the external electrical circuit and load.

Although not meant to be held by theory, the protons may also migrate along the surface of the nanotube and reduce the need for direct contact of the catalyst with the fuel cell electrolyte. Thus, the “effective contact area” of the catalyst with the electrolyte is increased through the connection of the catalyst particles with a network of single-wall carbon nanotubes in contact with the electrolyte, and thus, reducing the rate of proton-electron recombination at the anode and increasing the performance of the fuel cell.

Other physical properties of single-wall carbon nanotubes provide further efficiencies to fuel cell operation. Besides electrical conductivity, the high thermal conductivity of single-wall carbon nanotubes also has a positive effect on fuel cell efficiency. Since temperature gradients in fuel cell assemblies can reduce performance and lead to fuel cell failure, it is desirable for a fuel cell to be constructed in a way that reduces such temperature gradients. Incorporation of the highly, thermal conductive single-wall carbon nanotubes in one or both electrodes, improves heat distribution and reduces temperature gradients.

The mechanical and physical properties of single-wall carbon nanotubes are also beneficial in fabrication of fuel cell elements. The exceptional strength of the single-wall carbon nanotubes not only provides physical support for the small (nanometer-scale) catalyst particles, but also provides mechanical integrity useful for the formation of free-standing electrodes. In contrast to multi-wall carbon nanotubes and carbon black, single-wall carbon nanotubes have a sinuous structure that facilitates the formation of a thin free-standing conductive film.

Porosity in the fuel cell electrode assemblies is a desirable attribute in order for fuel and oxidizing gases to reach the supported catalyst particles. Carbon nanotubes can be made into structures that are permeable by liquids and gases. In some fuel cells, water is a reaction product and, in others, water is a diluent for the fuel, which means that water can be present on both the anode and cathode electrodes. It is desirable for the fuel cell electrode material to have both high porosity and hydrophobicity, so that that water is not retained in the electrodes and impair the electrode's ability to transmit gases. Carbon nanotube surfaces are highly hydrophobic and can be fashioned into gas- and liquid-permeable forms such as mats and membranes. Using electrodes comprising carbon nanotubes, and especially single-wall carbon nanotubes, can improve water transport in fuel cell electrodes that use or produce water.

MEAs with Catalyst Inks Comprising SWNT

In another embodiment of the present invention, electrodes comprising carbon nanotubes can be prepared with catalyst inks comprising carbon nanotubes and catalytic metal effective for catalyzing fuel cell reactions. Single-wall carbon nanotubes are preferred for formulation of such inks. PEM fuel cell electrodes can be prepared by applying a “catalyst ink” directly on to the polymer electrolyte membrane and/or to the gas diffusion layer. Conventional catalyst inks for PEM fuel cell electrodes can comprise catalyst metal, carbon black, a solvent, and an ionomeric material that is either the same as, or compatible with, the polymer electrolyte membrane material. An ionomer is a compound that can be added to the catalyst ink to impart to the dried-ink electrode, ion-conduction capabilities similar to, or compatible with, the electrolyte material. An example of a polymer electrolyte membrane is perfluorosulfonic acid/PTFE copolymer in acid (H⁺) form, commercially available as NAFION® perfluorinated polymer. (NAFION is a registered trademark of the E.I. du Pont de Nemours and Company.) An example of a compatible ionomer material is a dispersion of perfluorosulfonic acid/PTFE copolymer in the acid (H⁺) form, commercially available as NAFION polymer solution. After application on the polymer electrolyte membrane and/or gas diffusion layer, the catalyst ink dries to form a thin, catalyst-containing conductive electrode.

In one embodiment of the present invention, the catalyst ink comprises carbon nanotubes, which can be single-wall, multi-wall or a combination thereof. The ink can further comprise solvent, carbon black, carbon black with associated catalyst, an ionomer, or combinations thereof. To prepare a catalyst ink comprising carbon nanotubes, a suspension of carbon nanotubes is prepared. The carbon nanotubes can be pristine, non-covalently derivatized or covalently derivatized with a functional group. Catalytic metal can be deposited on the carbon nanotubes.

The carbon nanotube suspension, wherein the carbon nanotubes can have catalytic metal deposited on them, can be applied to the proton exchange membrane by an application technique, such as painting, spraying, evaporative deposition, centrifugation, or combination thereof. The carbon nanotube suspension can also be filtered on the gas diffusion component, so that the resulting form is single-wall carbon nanotubes on a gas diffusion layer. In the embodiment wherein the single-wall carbon nanotubes have been applied to a PEM, but do not have catalyst particles already on them, the catalytic metal is subsequently applied by any known means, such as, but not limited to solution methods with catalytic metal precursors, or vaporization or electroplating methods to deposit metallic forms of the catalyst.

In one embodiment, the carbon nanotubes are blended with another carbon form, such as carbon powder or carbon black, to form a catalyst ink. If the carbon nanotubes and the other carbon form do not have catalyst deposits on them, the catalytic metal is subsequently applied by any known means, such as, but not limited to solution methods with catalytic metal precursors, or vaporization or electroplating methods to deposit metallic forms of the catalyst.

In another embodiment, carbon nanotubes, without any catalytic metal deposits, are combined with another carbon form, such as carbon powder or carbon black, that has been loaded with catalytic metal.

Although ionomer in catalyst inks can provide more conductive pathways for ion migration to the electrolyte, catalyst inks containing ionomer are not particularly chemically stable, having shelf-lives of only hours to days. A more stable catalyst ink can be formulated with carbon nanotubes instead of ionomer, and result in inks that have shelf-lives of weeks to months. Although not meaning to be held by theory, carbon nanotubes, preferably single-wall carbon nanotubes, appear to serve a conductive function by providing additional pathways for ions to migrate through the electrode to the electrolyte. In one embodiment, the catalyst ink comprising carbon nanotubes does not contain an ionomer component.

The catalyst ink can comprise carbon nanotubes with or without catalyst metal or catalyst precursor, preferably, the carbon nanotubes have associated catalyst metal or metal precursor. The catalytic metal or catalyst metal precursor can comprise a metal selected from the group consisting of Group VI elements, which includes chromium (Cr), molybdenum (Mo) and tungsten (W), Group VII elements, which includes manganese (Mn), technetium (Tc) and rhenium (Re), Group VIII elements, which includes iron (Fe), ruthenium (Ru), osmium (Os), cobalt (Co), rhodium (Rh), iridium (Ir), nickel (Ni), palladium (Pd), and platinum (Pt), copper (Cu), silver (Ag), gold (Au), zinc (Zn), tin (Sn), aluminum (Al) or combinations thereof. Preferably, the catalytic metal or catalyst metal precursor comprises Ru, Rh, Pd, Os, Ir, Pt or a combination thereof. More preferably, the catalytic metal or catalyst metal precursor comprises Pt or a metal combination comprising Pt. For DMFC systems, the catalytic metal for the anode electrode preferably comprises Pt and Ru.

A membrane electrode assembly (MEA) comprising a polymer electrolyte membrane between two electrodes, can be made with a catalyst ink comprising carbon nanotubes. The carbon nanotubes and catalytic metal, wherein the catalytic metal can be on the carbon nanotubes, or, optionally, on another carbon source, or on both, are suspended in a liquid, which can be an organic solvent, an aqueous system or combination thereof. The suspension can then be deposited directly on the polymer electrolyte membrane to form an electrode. Deposition techniques include, but are not limited to, painting, spraying, subliming, flocculating, chemical deposition, electrolytic deposition, centrifugation, filtering the suspension using the component, and combinations thereof. Alternatively, or in addition to, depositing the nanotube mixture on the polymer electrolyte membrane, the deposition can be applied to a gas diffusion layer. In which case, the side of the gas diffusion layer with carbon nanotube deposit is contacted with the polymer electrolyte membrane, so that the electrode comprising the single-wall carbon nanotubes is between the gas diffusion layer and the polymer electrolyte membrane.

Another embodiment of this invention is a catalyst ink comprising a suspension of carbon nanotubes with catalytic metal precursors or particles deposited on the nanotubes. Alternatively, the ink may comprise an ionomer or other compound that is the same or compatible with the proton exchange membrane. The ionomer promotes ink adhesion and proton conduction to the proton exchange membrane. The carbon nanotube suspension can be applied to the proton exchange membrane by such application methods, as screen printing, spraying, electrospraying, transferring printing, dipping, painting, and combinations thereof.

The incorporation of carbon nanotubes in a catalyst ink enhances the performance of fuel cells, even when catalyst metal or metal precursors are loaded on an alternate carbon form, such as carbon black, and not loaded directly on the carbon nanotubes. Without being limited by theory, it appears that the presence of carbon nanotubes in the ink enhances the conductivity of the electrodes formed with the ink, and increases the effectiveness of the catalyst in the ink, so that lower catalyst loadings can be used to achieve the same fuel cell performance.

Incorporating carbon nanotubes in the electrode material of polymer electrolyte membrane-containing fuel cells, including direct methanol fuel cells (DMFC) and PEMFC operation on either pure or reformate hydrogen, gives higher performance than fuel cells made with catalyst-containing electrodes with other carbon forms, such as carbon black or carbon powder.

MEAs with a Nanotube Layer Between the Electrode and the PEM

Another embodiment of this invention is a PEM fuel cell, which can be a hydrogen PEMFC (operating with pure or reformate hydrogen), or a DMFC, comprising a layer of carbon nanotubes, wherein catalytic metal has not been applied to the nanotubes, in between and in contact with both the proton exchange membrane and an electrode. The carbon nanotubes can be single-wall, multi-wall, or a combination of both. The layer of carbon nanotubes is situated between, and in intimate contact with, the proton exchange membrane and an electrode material containing metal for catalyzing fuel cell reactions. The layer of carbon nanotubes can comprise an ionomer that is the same or compatible with the proton exchange membrane. The layer may be made by mixing the nanotubes, and optional ionomer resin, with a liquid and applying the nanotubes to the surface of the PEM and allowing the liquid to evaporate to form the nanotube layer. In one embodiment, carbon nanotubes are dispersed in a solvent, such as water or isopropanol. Sonication or other mixing means can be used to facilitate dispersion of the nanotubes. To the nanotube/solvent mixture, an ionomer resin, such as NAFION (perfluorovinylether sulfonic acid/tetrafluoroethylene copolymer) can be added. For DMFC-type fuel cells, the nanotubes are preferably mixed with an ionomer resin. Although not meant to be held by theory, the NAFION resin improves the wetting properties for liquid feed-type organic/air fuel cells, such as DMFCs. Although the nanotube layer can be applied to both sides of the PEM, the nanotube layer is preferably applied to anode side of the PEM such that the nanotube layer is between the catalyst-containing anode material and the PEM. The electrode material may also be applied as a catalyst ink or as made as a free-standing electrode and adhered to the nanotube layer with pressure and, optionally, heat.

Incorporation of a single-wall carbon nanotube/NAFION layer between a catalyst-containing anode and a NAFION PEM in a membrane electrode assembly (MEA) provides higher performance in a DMFC system than a comparably-prepared MEA without the nanotube layer. Although not meaning to be held by theory, the enhanced performance of the DMFC with nanotubes may be due to a number of factors, including, but not limited to, (1) reducing methanol crossover, which reduces DMFC performance and cell lifetime, due, in part, to poisoning the cathode's catalyst system, (2) enhancing electron conductivity and/or ion mobility to the PEM by providing conductive paths from the catalyst to the PEM or to the electronic circuit, and (3) providing improved heat conductivity for better heat removal.

The optimum electrode efficiency for a particular fuel cell application depends on a great number of variables, including, but not limited to, the particular fuel, gas-feed pressure and concentration, temperature, electrical load conditions, ambient temperature, and humidity. The optimal electrode configuration depends upon the catalyst concentration in the electrode, electrode density and electrode thickness.

Regardless if the electrodes are free standing or prepared with a catalyst ink, electrodes comprising carbon nanotubes, which may be single-wall, multi-wall, or a combination of both, provide greater flexibility in fuel cell design. When electrodes are configured with carbon nanotubes provide a means to reduce the metal catalyst loading, which has the potential for reducing cost. The catalyst loading can also be incorporated in the electrode as a gradient to further optimize the fuel cell performance.

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLE 1

Preparation of MEA Electrodes Comprising Single-Wall Carbon Nanotubes and Pt

22.8 mg chloroplatinic acid hexahydrate (Mol. Wt. 519.9, Aldrich No. 20,608-3) was dissolved in 10 mL EtOH to form a chloroplatinic acid stock solution. Chloroplatinic acid stock solution (184 μl) was added to 2.0 mg purified, HIPCO® single-wall carbon nanotubes, and the volume of the mixture was brought to 5 mL with EtOH. (HIPCO® single-wall carbon nanotubes were obtained from Carbon Nanotechnologies, Inc. HIPCO is a registered trademark of Carbon Nanotechnologies, Inc., Houston, Tex.) Prior to mixing with the chloroplatinic acid, the single-wall carbon nanotubes were purified with an air oxidation (˜200-300° C.) followed by an overnight Soxhlet extraction in about 18% HCl to remove catalytic residues. After purification, the residual iron in the nanotubes was about 7 wt % Fe. The SWNT was dispersed into the ethanol-diluted chloroplatinic acid solution by ultrasonication (2 min, 2 sec cycle, 30% duty cycle, 55% power output) to form a SWNT suspension. The SWNT suspension was heated at 50° C. for 4 hours with magnetic stirring to form platinum-complexed nanotubes. The Pt-complexed nanotubes were isolated from solution by vacuum filtration using a PVDF (polyvinylidene fluoride) membrane filter (47-mm diameter, 0.22-μm pore size, Millipore). After filtration, the Pt-complexed nanotubes were in the form of a 3.7-cm diameter solid thin film, which is referred to the “membrane electrode.” The resultant membrane electrode of Pt-complexed SWNT was washed with EtOH (20 ml) to remove excess, non-coordinated chloroplatinic acid. The membrane electrode was dried 12 hours under ambient conditions. The platinum loading on the SWNT was determined by ICP-MS (inductively-coupled plasma mass spectrometry) analysis to be 4 wt % Pt.

### EXAMPLE 2

Preparation of a SWNT-Based Membrane Electrode Assembly (MEA)

A membrane electrode assemblies (MEA) for use in a proton exchange membrane (PEM) fuel cell was prepared as follows using the membrane electrode of Pt-complexed SWNT made according to Example 1.

NAFION® N-1135, a perfluorosulfonic acid/polytetrafluoroethylene (PTFE) copolymer in the acid (H+) form, was used as the polymer electrolyte material (PEM) material. (NAFION is a registered trademark of E. I. du Pont de Nemours and Co. The NAFION membrane was obtained from Alfa Aesar, Ward Hill, Mass.) A square piece of NAFION PEM (3.5-in×3.5-in×90-μm) was sandwiched between an anode electrode membrane of Pt-complexed SWNT (as prepared in Example 1) and a cathode electrode material, comprising Pt and amorphous carbon. The cathode material was the cathode electrode of a PRIMEA® Series 55 MEA, specifically the cathode electrode from a PRIMEA 5510 MEA from Gore. (PRIMEA is a registered trademark of W. L. Gore & Associates, Inc., Elkton, Md.) The cathode had a platinum loading of 0.1 mg/cm².

The carbon-containing face of each membrane electrode was in direct planar contact with the PEM. The anode and cathode membrane electrodes of this MEA were thermally adhered to the PEM by pressing the assembly at 120° C. in a heated platen press (Carver) between PTFE-lined platens (6″×6″×0.25″-thick). While heated, the assembly was pressed together with a load of 3000 lbs, equating to about 83-85 psi, was applied for approximately three minutes. After pressing, the resultant MEA was removed from the PTFE-lined platens and allowed to cool to room temperature while being pressed only slightly between two steel platens, using the thermal mass of steel platens to control the rate of cooling. After approximately ten minutes, protective films (a PVDF backing film on the SWNT membrane electrode and a PTFE backing film on the amorphous carbon membrane electrode were peeled off of the MEA. The resulting MEA had an anode electrode and a cathode electrode adhered well to each planar surface of the PEM.

### EXAMPLE 3

Fuel Cell Comprising SWNT Electrode

A single stack, hydrogen-air, fuel cell was assembled to evaluate the power performance of different MEAs under standard conditions. Different MEAs were made according to Example 2 with different anodes, keeping the PEM and cathode material the same. The same cathode electrode material as described in Example 2, i.e. a cathode electrode of the PRIMEA 5510 MEA from Gore, was used and had a platinum loading of 0.1 mg/cm². The PEM was 90-μm-thick NAFION N-1135 (Dupont NAFION obtained from Alfa Aesar). The anodes comprised platinum-loaded single-wall carbon nanotubes, as prepared according to Examples 1 and 2. Each anode comprised different amounts of SWNT made from the same batch of platinum-loaded SWNT, per Example 1. Since the anodes comprised different amounts of Pt-loaded SWNT, the anodes had different thicknesses and also different surface platinum loadings per planar area of electrolyte membrane, proportional to the amount of Pt-loaded used in the anode.

In each case, a fuel cell was assembled by sandwiching the test MEA, made according to procedures given in Example 2, between two equivalent pieces of uncatalyzed ELAT® gas diffusion material. (ELAT gas diffusion material was obtained from E-TEK, De Nora N.A., Inc., Somerset, N.J. ELAT is a registered trademark of E-TEK.) The ELAT gas diffusion material was used to distribute hydrogen and air over both the anode and cathode, respectively. Once assembled, the fuel cell was connected to an automated gas and thermal management system to control temperature, gas flow rates and humidity of both hydrogen fuel and air supplies. Power output of the fuel cell was connected to a solid-state power management system to control electrical loads.

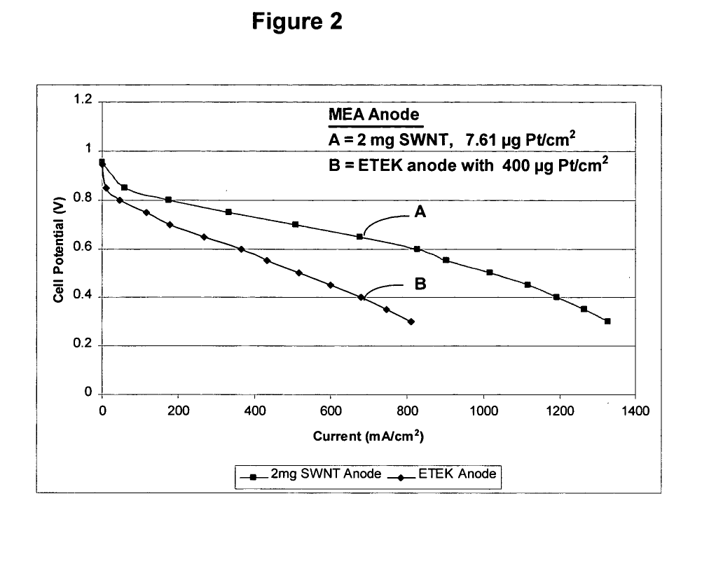

Power profiles (voltage versus current density output) of the fuel cell were recorded while maintaining a hydrogen/air flowrate ratio of 2/3.5 times the stoichiometric value theoretically needed to produce a given cell current output, a cell temperature of 70° C., an anode temperature of 80° C., a cathode temperature of 70° C., and fuel and air supply pressure of 30 psig to both the cathode and anode. The results of these measurements under the conditions given are shown in FIG. 2, which compares the anode performance of a 4 wt % Pt-loaded SWNT-based anode with that of an anode prepared with commercially available E-TEK materials (ELAT gas diffusion media and Pt on Vulcan XC-72 carbon at a platinum loading of 0.4 mg Pt/cm² planar surface area).

FIG. 2 shows a comparison between a hydrogen fuel cell anode electrode prepared from E-TEK commercial Pt-loaded amorphous carbon and a hydrogen fuel cell anode electrode prepared with single-wall carbon nanotubes. The nanotube-containing anode electrode gave a current density of greater than 800 mA/cm² at a cell potential of 0.6 volts, under the stated testing conditions. The surface catalyst loading on the single-wall carbon nanotube-containing anode was 7.61 μg Pt/cm² planar PEM area. FIG. 2 shows significantly higher anode performance, greater than 100% increase in current density at 0.6 V, with the SWNT-based MEA versus the Pt-loaded amorphous carbon-based anode. Curve A gives the performance of the PEM fuel cell with the anode electrode having 2 mg single-wall carbon nanotubes and a loading of 7.61 μm Pt/cm² planar PEM area. At a cell potential of 0.6V, the SWNT anode electrode gave a current density of 829 mA/cm². Curve B gives the performance of a PEM fuel cell having a commercial E-TEK anode electrode with a catalyst metal loading of 400 μm Pt/cm² planar PEM area. At a cell potential of 0.6V, the E-TEK anode electrode gave a current density of 364 mA/cm².

Similar measurements using other electrode materials indicate that there exists an optimum SWNT electrode mass to obtain the highest power performance. In general, higher fuel cell performance with a SWNT anode was achieved with thinner MEA constructions having less SWNT material. Although the anode comprised of 1 mg SWNT gave lower results, this could be due to the fact that it was very fragile and was possibly damaged during MEA fabrication.

The anode electrode made from Pt-loaded amorphous carbon had a figure of merit (at 0.6 Volt cell potential) of about 0.88 mA/cm² per μg Pt/cm² planar electrolyte membrane area. An anode electrode prepared according to Examples 1, 2 and 3 using an anode comprising 2 mg SWNT and 7.61 μg/cm² planar electrolyte membrane shows a figure of merit of approximately 108 mA/cm² per μg Pt/cm² of electrolyte membrane area. The use of single-wall carbon nanotubes provided over a 100-fold increase in the current density per μg Pt/cm² of electrolyte membrane at 0.6 Volt cell potential. The anode electrode comprising SWNT provided greater current density at a substantially lower platinum catalyst loading.

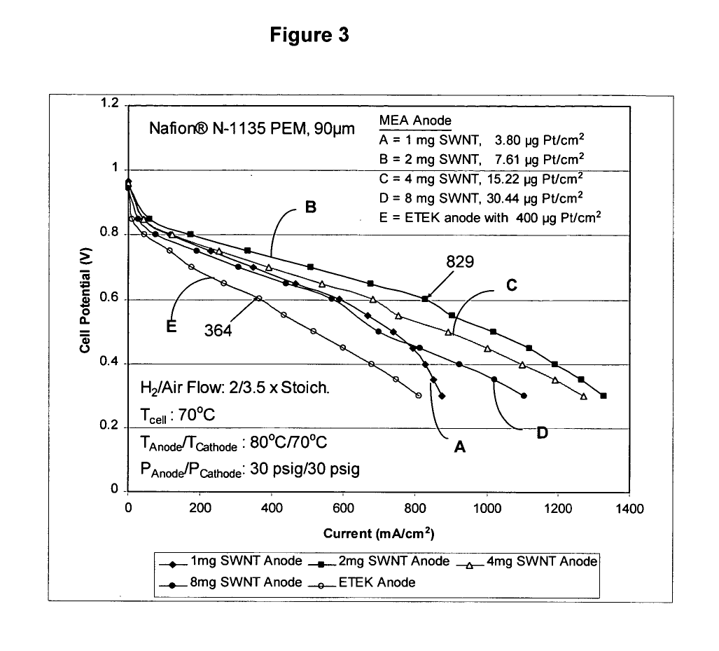

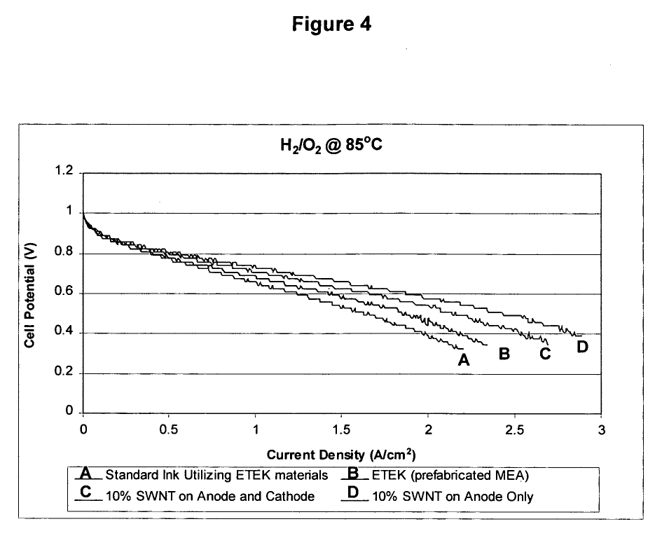

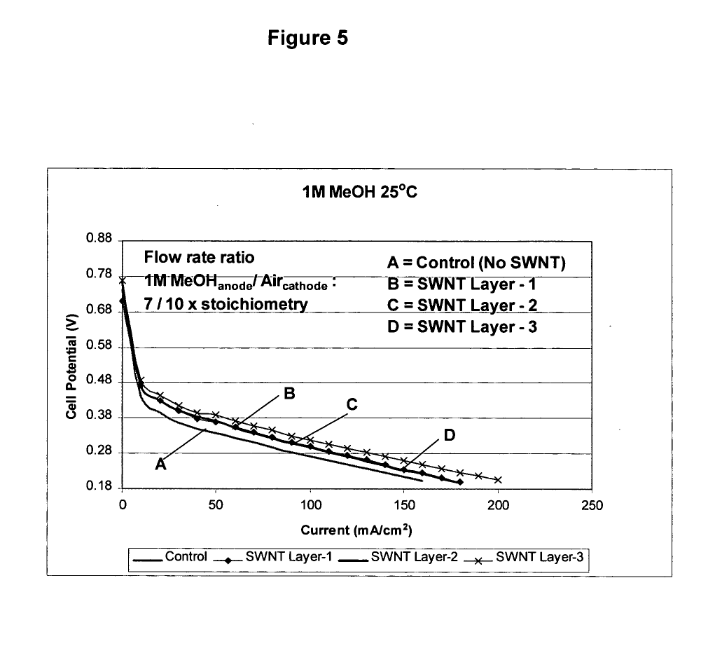

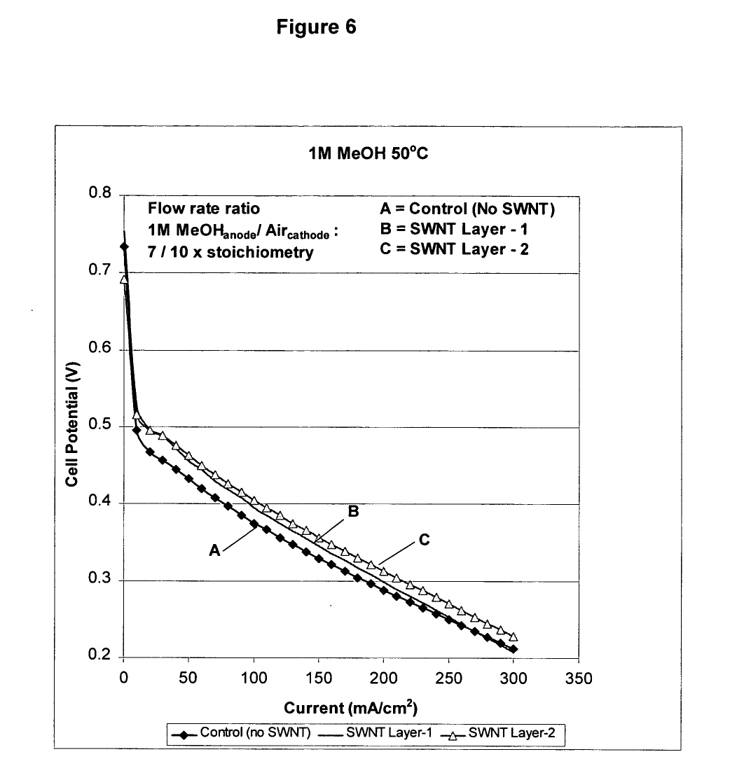

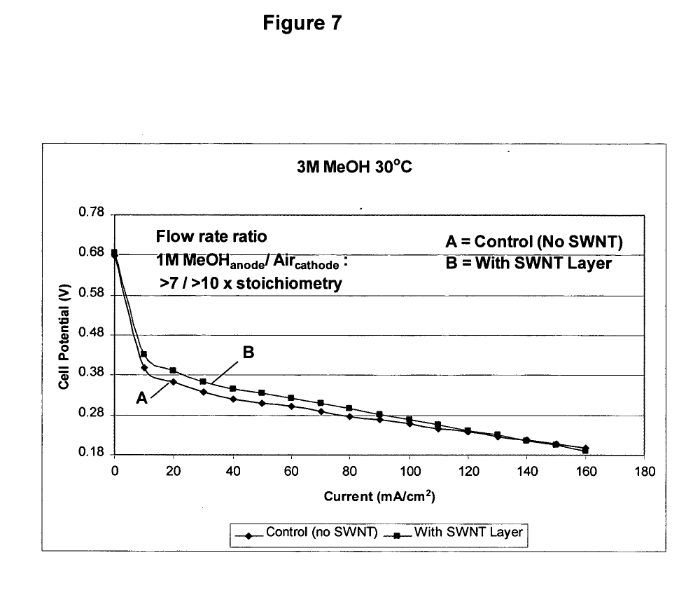

FIG. 3 shows the performance of fuel cells using different anodes comprising different amounts of SWNT having the same platinum loading per weight of SWNT. Because different amounts of SWNT were used, the platinum loading per area of PEM is proportional to the amount of Pt-loaded SWNT used to make the anode. A catalyzed amorphous carbon electrode from Gore was used as the cathode for all fuel cell constructions. The cathode material was the cathode electrode of a Gore PRIMEA 5510 having a platinum loading of 0.1 mg/cm². Fuel cell operating conditions were hydrogen/air flow rate (2/3.5× times the stoichiometric value theoretically needed to produce a given cell current output), cell temperature (70° C.), T_{anode}/T_{cathode}: 80° C./70° C., and P_{anode}/P_{cathode}: 30 psig/30 psig.

The fuel cells having MEAs prepared with SWNT-based anodes had consistently higher cell potential for a given current density than the E-TEK anode, comprising ELAT with 20% Pt on Vulcan XC-72, which had a much higher overall loading of platinum, i.e. 400 μg Pt/cm² of planar membrane surface area.

FIG. 3 shows plots of fuel cell current density as a function of cell potential for different anodes comprising different amounts of Pt-loaded single-wall carbon nanotubes. The highest performance under the testing conditions was given by a MEA having an anode with 2 mg SWNT having 7.61 μg Pt/cm² of membrane area. This example shows that fuel cell properties, such as current density profile, can be varied according to the amount of single-wall carbon nanotubes and catalyst loading per electrolyte membrane area. The amount of SWNT can affect the porosity and thickness of the electrolyte, which can affect gas diffusion and heat dissipation, among other properties. Generally, the thinner SWNT electrodes gave better performance, with the anode having 2 mg SWNT giving better performance than the anode having 4 mg SWNT and the 4 mg SWNT anode giving better performance than the anode having 8 mg SWNT. The anode electrode with 1 mg SWNT and 3.80 μg Pt/cm² PEM surface area may have given better results, but the membrane was fragile and may have been damaged in preparation of the MEA. All of the SWNT-based anodes gave better fuel cell performance than the amorphous carbon anode electrode which had a much higher platinum loading.

### EXAMPLE 4

Fuel Cell Having Electrodes Prepared with Ink Comprising SWNT

Fuel cell electrodes were prepared with inks comprising single-wall carbon nanotubes and compared to electrodes prepared with platinum-loaded carbon powder.

Preparation of a Catalyst Ink Comprising Platinum-Loaded Carbon Powder

A 5% solution of NAFION in isopropyl alcohol/water (DuPont NAFION was obtained from Alfa Aesar, Product No. 42118) was mixed on a mixing plate in a 7-mL vial, held at 0° C. with temperature control provided by an ice bath, with 250 mg of a 1:1 (vol:vol) isopropyl alcohol:water solution. As a general procedure, an additional 125 mg of IPA/water solution could be added if the mixture started to gel. 25 mg carbon powder loaded with 20% platinum (Vulcan XC-72 manufactured by E-TEK) was added slowly to the NAFION mixture. While still in contact with the ice bath, the mixture was ultrasonically mixed for 10 minutes. The mixture was further mixed on the mixing plate for 30 minutes to ensure complete mixing.

Preparation of a Catalyst Ink Comprising SWNT and Pt-Loaded Carbon Powder

125 mg of 5% solution of NAFION in isopropyl alcohol/water (DuPont NAFION was obtained from Alfa Aesar, Product No. 42118) was mixed on a mixing plate in a 7-mL vial, held at 0° C. using an ice bath, with 250 mg of a 1:1 (vol:vol) isopropyl alcohol:water solution. As a general procedure, an additional 125 mg of IPA/water solution could be added if the mixture started to gel. 2.5 mg HIPCO single-wall carbon nanotubes (Lot. P₀₂₄₂ obtained from Carbon Nanotechnologies, Inc.) were mixed with 25 mg carbon powder loaded with 20% platinum (Vulcan XC-72 manufactured by E-TEK) and the nanotube/carbon powder mixture was added slowly to the NAFION mixture. While still in contact with the ice bath, the mixture was ultrasonically mixed for 10 minutes. The mixture was further mixed on the mixing plate for 30 minutes to ensure complete mixing.

Gas diffusion fabric one-side coated with carbon and having no catalyst (SS/NC/V2/ELAT obtained from E-TEK) was used to make the anode and cathode for the MEAs. 2.25×2.25-cm squares of the ELAT were cut and weighed (sample area was about 5 cm²). Up to four ELAT samples were coated at once on a heated aluminum block with a rubber gasket. The heated block provided heat to evaporate the solvent during the painting process. To prepare the electrodes, catalyst ink was painted with a small brush in one direction onto the carbon-coated side of the ELAT fabric. When the ink was dry, the ink-coated sample was removed from the heated block and weighed. The target Pt loading for the electrode was 0.5 mg/cm² which corresponds to the weight addition of 12.5 mg for carbon having 20% Pt without SWNT or 13.75 mg for carbon with 20% Pt including 10% SWNT.

Ink application was repeated until the desired loading (Pt/cm²) per was achieved. After the desired Pt loading was obtained, two coats of 5% NAFION/IPA solution were applied to further promote adhesion of the electrodes to the ELAT fabric gas diffusion layer.

FIG. 4 shows the performance of fuel cells with MEAs (membrane electrode assemblies) prepared by painting inks on a polymer electrolyte membrane.

Curve A shows the performance of a fuel cell having electrodes made with an ink having the ingredients: 5% NAFION/isopropyl alcohol (IPA) solution, 1:1 IPA/water solution, and Vulcan XC-72 (20% platinum on carbon powder, manufactured by E-TEK).

Curve B shows the performance of a fuel cell based on standard ink using Vulcan-XC-72 (20% Pt on carbon powder) without SWNT.

Curve C shows the performance of a fuel cell having an anode and a cathode based on the ink of “curve a” to which was added 10 wt % single-wall carbon nanotubes.

Curve D shows the performance of a fuel cell having an anode based on the ink of “Curve A” to which was added 10 wt % single-wall carbon nanotubes. No SWNT was in the cathode. The addition of SWNT to the anode ink gave greater fuel cell performance than without SWNT.

### EXAMPLE 5

This example demonstrates the use of single-wall carbon nanotubes in a direct methanol fuel cell. In particular, a layer of nanotubes, without associated catalyst, was sandwiched between an anode electrode prepared with a standard catalyst ink and a PEM layer.

2 mg purified, HIPCO single-wall carbon nanotubes were added to 250 mg water. (Nanotube purification was done with an air oxidation (˜200-300° C.) followed by an overnight Soxhlet extraction using about 18% HCl to remove catalytic iron residues. After purification, the residual iron in the nanotubes was about 4 wt % Fe. The nanotube/water mixture was immersed in an ice bath (0° C.) and sonicated in a pulse mode for 10 minutes. 6 mg 5% NAFION/isopropyl alcohol/water solution was added to the nanotube/water mixture and the nanotube/NAFION solution/water mixture was sonicated in the pulse mode for another 10 minutes. The sonicated nanotube/NAFION solution/water mixture was painted on to a NAFION proton exchange membrane (NAFION 117). The water and isopropanol was allowed to evaporate from the nanotube/NAFION mixture. After the nanotube/NAFION application appeared dry, a standard catalyst ink was painted on top of the nanotube/NAFION application to form a DMFC anode electrode.

The standard catalyst ink was prepared with HISPEC™ 6000 as the catalyst. (HISPEC is a powdered alloy containing 60 wt % Pt and 30 wt % Ru (ruthenium). HISPEC is a trademark of Johnson Matthey, PLC.). While immersed in an ice bath, 39.1 mg HISPEC 6000 was mixed with 313 mg water using sonication in a pulse mode for 10 minutes. 117 mg 5% NAFION/isopropanol/water solution was added to the HISPEC/water mixture held at 0° C. and sonicated in the pulse mode for another 10 minutes. The resulting catalyst ink was then used to paint four electrodes having an area of approximately 4.4 cm² each, with a target metal loading of 2 mg metal/cm² on each electrode.

The electrodes with and without single-wall carbon nanotube layers were tested as anodes in direct methanol fuel cell operated under different conditions.

FIG. 5 shows a performance plot of cell potential versus current density for DMFC systems with 1 molar (M) methanol to the anode and air to the cathode at 25° C. (ambient temperature). The flow rate ratio of the 1 M methanol/air was 7/10 times the stoichiometric value theoretically needed to produce a given cell current output. Curve A in FIG. 5 is the control anode electrode without a SWNT/NAFION layer. Curves B, C and D in FIG. 5 represent the performance of DMFCs for MEAs made in triplicate with the same construction and starting materials using a SWNT/NAFION layer between the PEM and the standard catalyst ink anode electrode. The MEAs having a SWNT layer between the PEM and the catalyst ink electrode had consistently higher performance than the MEA only having the standard catalyst ink.

FIG. 6 shows a performance plot of cell potential versus current density for DMFC systems with 1 M methanol to the anode and air to the cathode at 50° C. (ambient temperature). The flow rate ratio of the 1 M methanol/air was 7/10 times the stoichiometric value theoretically needed to produce a given cell current output. Curve A in FIG. 6 is the control anode electrode without a SWNT/NAFION layer. Curves B and C in FIG. 6 represent the performance of DMFCs for MEAs made in duplicate with the same construction and starting materials using a SWNT/NAFION layer between the PEM and the standard catalyst ink anode electrode. The MEAs having a SWNT layer between the PEM and the catalyst ink electrode had consistently higher performance than the MEA only having the standard catalyst ink.

FIG. 7 shows a performance plot of cell potential versus current density for DMFC systems with 3 molar (M) methanol to the anode and air to the cathode at 30° C. (ambient temperature). The flow rate ratio of the 3 M methanol/air was >7/>10 times the stoichiometric value theoretically needed to produce a given cell current output. Curve A in FIG. 7 is the control anode electrode without a SWNT/NAFION layer. Curve B in FIG. 7 represents the performance of a DMFC for an MEA using a SWNT/NAFION layer between the PEM and the standard catalyst ink anode electrode. The MEA having a SWNT layer between the PEM and the catalyst ink electrode had higher performance than the MEA only having the standard catalyst ink.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the method described herein without departing from the concept, spirit and scope of the invention. More specifically, it will be apparent that certain agents which are chemically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A proton electrolyte membrane fuel cell electrode, comprising:
(a) a plurality of carbon nanotubes, wherein the plurality forms a mat of carbon nanotubes, wherein the mat has a planar area and wherein the mat has a thickness greater than one micron, and
(b) a catalyst metal selected from the group consisting of chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), tin (Sn), aluminum (Al), and combinations thereof, in contact with the mat of carbon nanotubes.

2. The electrode of claim 1 wherein the carbon nanotubes are selected from the group consisting of single-wall carbon nanotubes, multi-wall carbon nanotubes and a combination thereof.

3. The electrode of claim 1 wherein the carbon nanotubes are derivatized with a functional group.

4. The electrode of claim 3 wherein the functional group is a carboxylic acid group.

5. The electrode of claim 1 wherein the catalyst metal comprises platinum.

6. The electrode of claim 1 wherein the catalyst metal comprises platinum and ruthenium.

7. The electrode of claim 1 wherein the catalyst metal is present in an amount less than 400 μg/cm² of the planar area of the mat of the carbon nanotubes.

8. The electrode of claim 1 wherein the catalyst metal is present in an amount less than 100 μg/cm² of the planar area of the mat of the carbon nanotubes.

9. The electrode of claim 1 wherein the catalyst metal is present in an amount less than 50 μg/cm² of the planar area of the mat of the carbon nanotubes.

10. The electrode of claim 1 wherein the catalyst metal is present in an amount less than 25 μg/cm² of the planar area of the mat of the carbon nanotubes.

11. The electrode of claim 1 wherein the catalyst metal is present in an amount less than 10 μg/cm² of the planar area of the mat of the carbon nanotubes.

12. The electrode of claim 1 wherein the electrode is a component in a hydrogen/oxygen proton exchange membrane fuel cell (PEMFC).

13. The electrode of claim 1 wherein a) the electrode is a component in a hydrogen/oxygen PEMFC, wherein b) the catalyst metal comprises platinum, wherein c) the carbon nanotubes are single-wall carbon nanotubes, and wherein d) the electrode provides greater than 1 mA/cm² per μg Pt/cm² of the planar area of the mat of carbon nanotubes.

14. The electrode of claim 13 wherein the electrode provides greater than 10 mA/cm² per μg Pt/cm² of the planar area of the mat of carbon nanotubes.

15. The electrode of claim 13 wherein the electrode provides greater than 50 mA/cm² per μg Pt/cm² of the planar area of the mat of carbon nanotubes.

16. The electrode of claim 13 wherein the electrode provides greater than 100 mA/cm² per μg Pt/cm² of the planar area of the mat of carbon nanotubes.

17. The electrode of claim 1 wherein the electrode is a component in a direct methanol fuel cell (DMFC).

18. A method for preparing a fuel cell membrane electrode, comprising
(a) associating a catalytic metal selected from the group consisting of a catalyst metal selected from the group consisting of chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), tin (Sn), aluminum (Al), and combinations thereof, with a plurality of carbon nanotubes to form a plurality of carbon nanotubes with associated catalytic metal, and
(b) forming a membrane electrode comprising a plurality of carbon nanotubes with associated catalytic metal.

19. The method of claim 18 wherein the carbon nanotubes are selected from the group consisting of single-wall carbon nanotubes, multi-wall carbon nanotubes and a combination thereof

20. The method of claim 18 wherein the plurality of carbon nanotubes are derivatized with a functional group.

21. The method of claim 20 wherein the functional group is a carboxylic acid group.

22. The method of claim 18 wherein associating is done by a method selected from the group consisting of chemical vapor deposition, electrochemical deposition, physical vapor deposition, thermal deposition, cathodic arc deposition, ion sputtering, evaporative sputtering, molecular beam epitaxy, ion beam assisted deposition, jet vapor deposition, and combinations thereof.

23. The method of claim 18 wherein the associating is done by a method selected from the group consisting of chemical deposition, electrochemical deposition, evaporative sputtering, molecular beam epitaxy, and combinations thereof.

24. The method of claim 18 wherein the catalytic metal comprises platinum.

25. The method of claim 18 wherein the catalytic metal comprises platinum and ruthenium.

26. The method of claim 18 wherein the associating is done by chemical deposition of a catalyst metal precursor.

27. The method of claim 26 wherein the catalyst metal precursor comprises chloroplatinic acid.

28. The method of claim 26 wherein the catalyst metal precursor is converted to a catalytically active metal by subjecting the catalyst metal precursor to metal reduction.

29. The method of claim 28 wherein metal reduction is done by a method selected from the group consisting of hydrogen reduction, chemical reduction, and a combination thereof.

30. The method of claim 29 wherein the metal reduction is done by hydrogen reduction.

31. The method of claim 28 wherein the catalytically active metal is in the form of metal particles on the carbon nanotubes.

32. The method of claim 18 wherein the forming is done on a proton exchange membrane by a method selected from the group consisting of painting, spraying, subliming, electrolytic deposition, centrifugation, filtering a suspension using the element, and combinations thereof.

33. The method of claim 18 wherein the forming is done on a gas diffusion layer by a method selected from the group consisting of painting, spraying, subliming, electrolytic deposition, centrifugation, filtering a suspension using the element, and combinations thereof.

34. The method of claim 18 further comprising mixing an ionomeric resin with the plurality of carbon nanotubes with associated catalytic metal.

35. The method of claim 34 wherein the ionomeric resin comprises a perfluorosulfonic acid/PTFE copolymer.

36. A membrane electrode assembly, comprising a proton exchange membrane, an anode electrode, a cathode electrode and carbon nanotubes, wherein the carbon nanotubes are positioned between the anode electrode and the proton exchange membrane.

37. The membrane electrode assembly of claim 36 wherein the carbon nanotubes are selected from the group consisting of single-wall carbon nanotubes, multi-wall carbon nanotubes and a combination thereof.

38. The membrane electrode assembly of claim 36 wherein the carbon nanotubes are coated with perfluorosulfonic acid/PTFE copolymer.

39. The membrane electrode assembly of claim 36 wherein the membrane electrode assembly is in a hydrogen/oxygen PEM fuel cell.

40. The membrane electrode assembly of claim 36 wherein the membrane electrode assembly is in a direct methanol fuel cell.

41. A method for preparing an membrane electrode assembly, comprising:
(a) preparing an ink comprising carbon nanotubes and catalytic metal; and
(b) coating the ink on one or more sides of a proton exchange membrane.

42. The method of claim 41 wherein the carbon nanotubes are selected from the group consisting of single-wall carbon nanotubes, multi-wall carbon nanotubes and a combination thereof.

43. The method of claim 41 wherein the ink further comprises a perfluorosulfonic acid/PTFE copolymer.

44. The method of claim 41 wherein the catalytic metal is selected from the group consisting of chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), tin (Sn), aluminum (Al), and combinations thereof.

45. The method of claim 41 wherein the catalytic metal comprises platinum.

46. The method of claim 41 wherein the catalytic metal comprises platinum and ruthenium.

47. A catalyst ink comprising carbon nanotubes and catalytic metal selected from the group consisting of consisting of chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), tin (Sn), aluminum (Al), and combinations thereof.

48. The catalyst ink of claim 47 wherein the catalytic metal comprises platinum.

49. The catalyst ink of claim 47 wherein the catalytic metal comprises platinum and ruthenium.

50. The catalyst ink of claim 47 wherein the carbon nanotubes are selected from the group consisting of single-wall carbon nanotubes, multi-wall carbon nanotubes and a combination thereof.

51. The catalyst ink of claim 47 further comprising an ionomeric resin.

52. The catalyst ink of claim 51 wherein the ionomeric resin comprises a perfluorosulfonic acid/PTFE copolymer.

53. The catalyst ink of claim 47 wherein the ink is in contact with a proton exchange membrane.

54. The catalyst ink of claim 47 wherein the ink is a component of a fuel cell.

55. The catalyst ink of claim 54 wherein the fuel cell is a PEM fuel cell.

56. The catalyst ink of claim 54 wherein the fuel cell is a DMFC.

57. A PEM fuel cell comprising an anode electrode, a cathode electrode and a proton exchange membrane, wherein the anode electrode comprises single-wall carbon nanotubes and wherein the single-wall carbon nanotubes support platinum-containing metal particles.

58. The fuel cell of claim 57 wherein the cathode electrode comprises single-wall carbon nanotubes wherein the single-wall carbon nanotubes support platinum-containing metal particles.

59. The fuel cell of claim 57 wherein the single-wall carbon nanotubes in the anode electrode are derivatized with a functional group.

60. The fuel cell of claim 57 wherein the single-wall carbon nanotubes in the cathode electrode are derivatized with a functional group.

61. The fuel cell of claim 57 wherein the fuel cell is a single stack fuel cell.

62. The fuel cell of claim 57 wherein the fuel cell is a multi-stack fuel cell.
